(19) United States
(12) Patent Application Publication
(10) Pub. No.: US 2006/0037563 A1
(43) Pub. Date: Feb. 23, 2006

(54) Internal combustion engine with auto ignition

(76) Inventors: Alois Raab, Bobingen (DE); Martin Schnabel, Aalen (DE)

Correspondence Address: KLAUS J. BACH, 4407 TWIN OAKS DRIVE, MURRYSVILLE, PA, 15668, US

(21) Appl. No.: 11/241,769

(22) Filed: Sep. 30, 2005

Related U.S. Application Data
(63) Continuation-in-part of application No. PCT/EP04/03339, filed on Mar. 30, 2004.

(30) Foreign Application Priority Data
Apr. 3, 2002 (DE) 103 15 149.4

(51) Int. Cl. F02B 47/02; F02B 3/00

(52) U.S. Cl. 123/25 C; 123/299

(57) ABSTRACT

In a method for operating an internal combustion engine in which fuel is injected directly into a combustion chamber in a pre-injection and a main fuel injection step, and, if appropriate, also in a post-injection step by means of an injection nozzle with a plurality of injection bores, the injection of fuel takes place in a timed fashion and, to limit pressure and temperature during combustion of the fuel in the combustion chamber, a quantity of water is introduced into the combustion chamber during or after the pre-injection step.

This is a Continuation-In-Part application of International application PCT/EP2004/003339 filed Mar. 30, 2004 and claiming the priority of German application 103 15 199.4 filed Mar. 4, 2003.

### BACKGROUND OF THE INVENTION

The invention relates to a method for operating an internal combustion engine with auto-ignition, in particular a diesel internal combustion engine, in which fuel is injected into a combustion chamber in different stages.

In direct injection internal combustion engines with auto-ignition, due to the principle involved the heterogeneous kind of combustion control by the auto-ignition of the injected fuel inevitably leads to very high pressures and high combustion temperatures in the combustion chamber, which, in particular, cause high NOx emissions. Furthermore, as a result of the fuel-rich zones considerable quantities of particles of soot are formed which are partially oxidized at the high temperatures present. In order to avoid the disadvantages of such a heterogeneous method of combustion control, a combined homogeneous/heterogeneous method of operation with which improved combustion is to be achieved, is aimed at for modern internal combustion engines with auto-ignition.

EP 509 372 B1 discloses a method in which a gaseous main fuel and liquid secondary fuel are used with the secondary fuel initiating the ignition of the main fuel. In this context, the liquid secondary fuel is injected into the combustion chamber as a mixture of water and fuel in the form of a pilot injection. The mixture of water with the liquid fuel has the purpose of permitting the pilot injection to initiate the ignition of the main fuel and of selecting the volume of the mixture injected by the pump in such a way that the atomization by the injection nozzle can be precisely configured.

EP 459 083 B1 discloses a method for operating an internal combustion engine in which water and diesel fuel are used and are introduced into the combustion chamber of the internal combustion engine by injecting fuel and water in such a way that firstly a quantity of fuel between 5% or more and 75% or less of an overall fuel injection quantity is injected during an injection, then a predetermined quantity of water is injected, and finally the remaining fuel is injected. In this water/diesel fuel internal combustion engine, both the fuel and the water are injected into the combustion chamber via a single fuel injection valve so that a rise in temperature of a flame is suppressed in order to minimize the generation of NOx emissions.

At the present state of the art, the combustion described above is very difficult to control since the rise in pressure in the combustion chamber depends on the fuel components in the pre-injection and main injection, the ignition time of the pre-injection, the ignition time of the main injection and on the injection time of the pre-injection and of the main injection.

It is therefore the object of the present invention to provide a method for operating an internal combustion engine with auto-ignition in such a way that a complete combustion and good distribution of the fuel in the combustion chamber are obtained while large pressure increases in the combustion chamber and high combustion temperatures are avoided.

### SUMMARY OF THE INVENTION

In a method for operating an internal combustion engine in which fuel is injected directly into a combustion chamber in a pre-injection and a main injection phase, and, if appropriate, in a post-injection phase by means of an injection nozzle with a plurality of injection bores, the pre-injection of fuel takes place in a timed fashion and, to limit pressure and temperature during combustion of the fuel in the combustion chamber, a quantity of water is introduced into the combustion chamber during or after the pre-injection phase.

As a result, the maximum combustion temperature is also reduced. The cooling liquid with a high evaporation enthalpy is advantageously introduced into the combustion chamber during the intake stroke and/or the compression stroke. Furthermore, the ignition time of the pre-injection and/or main injection may be delayed as a function of the quantity of fuel injected during the pre-injection phase. As a result of the liquid which is introduced into the combustion chamber and which serves as a cooling medium the fuel is cooled, delaying the ignition of the main injection so that an optimum center point for the combustion is obtained and a large rise in pressure in the combustion chamber is avoided. Exhaust gas may be recirculated in order to further reduce the exhaust gas emissions, in particular the formation of NOx.

In a refinement of the invention, the liquid is introduced into the combustion chamber before or after the start of the pre-injection. As a result of the virtually simultaneous injection of the cooling liquid, the presence of the cooling liquid during the pre-injection brings about, by virtue of the high evaporation enthalpy of the liquid, the aimed-at cooling effect before the ignition of the homogenous mixture which is formed by the early pre-injection. As a result, the ignition time of the pre-injection is delayed, the rise in pressure in the combustion chamber is reduced and the temperature level is lowered.

According to a further refinement of the invention, the liquid is introduced into the combustion chamber after the ending of the pre-injection. The introduction of the liquid which serves as a cooling medium takes place in this case after the ignition of the homogenous mixture or after the start of the ignition of the homogenous mixture, as a result of which the pressure increase in the combustion chamber and the maximum temperature are limited.

According to a further refinement of the invention, the introduction of the liquid into the combustion chamber ceases before the end of the main injection of the fuel. In this context, the introduction of the cooling medium influences both the combustion of the homogenous pre-mixture and the combustion of the heterogeneous component of the main injection, so that the pressure increase is limited and the temperature level is lowered. As a result, the start of the injections and the pressure profile of the combustion can be optimized.

In a further refinement of the invention, the liquid is introduced into the combustion chamber in the form of a quantity of water. As a result, heat is extracted from the fuel or the mixture present in the combustion chamber without a change in the composition of the mixture. This is expedient and appropriate in particular in a combustion method with pre-injection, main injection and, if appropriate, post-injection since the injection times and quantities of fuel of the respectively performed partial injections are controlled as a function of the engine operating point. Nevertheless, it is conceivable in accordance with the invention, that, instead of introducing water, a different liquid with a comparably high evaporation enthalpy is used. Alternatively, it is possible here to introduce a second fuel which has a comparably high evaporation enthalpy to water.

In still a further refinement of the invention, the quantity of water is added to the fuel during the pre-injection and/or the main injection within the injection device in such a way that the water is introduced into the combustion chamber in the form of a fuel/water emulsion. As a result, the aimed-at cooling effect is ensured since the water and fuel are mixed already before the injection of the fuel into the combustion chamber.

In another embodiment of the invention, the quantity of water is introduced into the combustion chamber by means of an additional injection device. The introduction of the water via a separate injector allows high fuel injection pressures to be performed without having to consider the use of water in the fuel injection device.

According to a further refinement of the invention, the quantity of water is added to the fuel during pre-injection and/or the main injection within the injection device in such a way that the water is introduced into the combustion chamber in the form of a stratified fuel/water/fuel arrangement or stratified fuel/water arrangement or stratified water/fuel arrangement.

In a further refinement of the invention, the pre-injection is performed in a compression stroke range approximately 150° CA to 30° CA before the top dead center position of the piston. In this case, the pre-injection is preferably carried out in a clocked fashion. The early pre-injection and possibly performed clocking of the pre-injection homogenizes to a greater degree the basic mixture composed of fuel, air and, if appropriate, exhaust gas so that subsequent or simultaneous introduction of the quantity of water can also bring about selective cooling.

According to a further refinement of the invention, the main injection and, if appropriate, the post-injection are performed in series about the top dead center in a range of 20° CA before the top dead center to 40° CA after the top dead center.

In a further refinement of the invention, the pressure of the fuel introduced into the combustion chamber is changed during an injection process. This is intended to avoid wetting of the walls of the combustion chamber with fuel. The injection pressure is preferably varied as a function of the operating point and/or in accordance with a counter pressure prevailing in the combustion chamber, so that the wetting of the wall with fuel is minimized.

According to a further refinement of the invention the pre-injection is performed in a clocked fashion, with a fuel-jet cloud generated during an injection stroke being offset or laterally shifted during the pre-injection by means of a swirl movement performed in the combustion chamber so that during a subsequent injection stroke the newly injected fuel jets do not penetrate the cloud of fuel of the preceding injection stroke. As a result, wetting of the walls of the combustion chamber with fuel is avoided and a greater degree of homogenization of the pre-injected quantity of fuel is achieved.

The invention will become more readily apparent from the following description of exemplary embodiments thereof illustrated in simplified form in the accompanying drawings:

### BRIEF DESCRIPTION OF THE DRAWINGS

FIG. 1 is a schematic cross sectional view of a direct injection internal combustion engine with auto-ignition,

FIG. 2 is a diagram of a schematic cylinder pressure profile during the combustion of a homogenous mixture of the internal combustion engine according to FIG. 1 without using a cooling medium and exhaust gas recirculation,

FIG. 3 is a schematic illustration of the fuel injection times of the combustion according to FIG. 2,

FIG. 4 shows schematically cylinder pressure profile of the internal combustion engine of FIG. 1 during the combustion of a homogenous mixture with exhaust gas recirculation and injection of water,

FIG. 5 shows schematically a cylinder pressure profile of a homogenous/heterogeneous combined combustion of the internal combustion engine according to FIG. 1 without using a cooling medium and without exhaust gas recirculation,

FIG. 6 is a schematic illustration of a fuel injection strategy of the combustion according to FIG. 5,

FIG. 7 is a schematic illustration of a fuel injection strategy of a homogenous/heterogeneous combined combustion with injection of water of the internal combustion engine according to FIG. 1,

FIG. 8 is a schematic illustration of a second exemplary embodiment of the combustion according to FIG. 7,

FIG. 9 is a schematic illustration of a third exemplary embodiment of the combustion according to FIG. 7,

FIG. 10 is a schematic illustration of a fourth exemplary embodiment of the combustion according to FIG. 7,

FIG. 11 is a schematic illustration of a fifth exemplary embodiment of the combustion according to FIG. 7, and

FIG. 12 is a diagram showing a cylinder pressure profile of a homogenous/heterogeneous combined combustion in the internal combustion engine according to FIG. 1 with injection of water.

### DESCRIPTION OF THE VARIOUS EMBODIMENTS

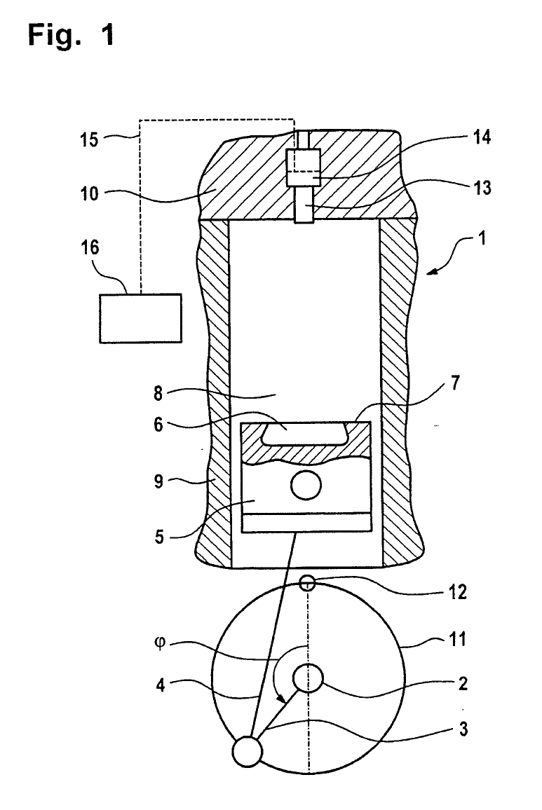

FIG. 1 shows an internal combustion engine 1 in which a crankshaft 2 is driven by a piston 5, which is guided in a cylinder 9, via a connecting rod 4. A combustion chamber 8 which preferably comprises a piston recess 6 formed in the piston head 7 is constructed in the cylinder 9, between the piston 5 and a cylinder head 10. When a crank 3 of the crankshaft 2 rotates on a crank circle 11 in the clockwise direction, the combustion chamber 8 becomes smaller, during which process the air enclosed therein is compressed. The charge cycle in the combustion chamber 8 is carried out by means of gas exchange valves (not illustrated) which are arranged in the cylinder head 10.

At a top dead center position 12 of the crank 3, referred to below as TDC, that is the end of the compression, the combustion chamber 8 has its smallest volume. The current position of the piston 5 is determined by the crank angle φ with respect to TDC. A multi-hole injection nozzle 13 is arranged virtually centrally in the cylinder head 10, and is actuated by an electronic control unit 16 of an engine controller via a signal line 15 and an actuator 14, for example a piezoelectric actuator or a hydraulic actuator.

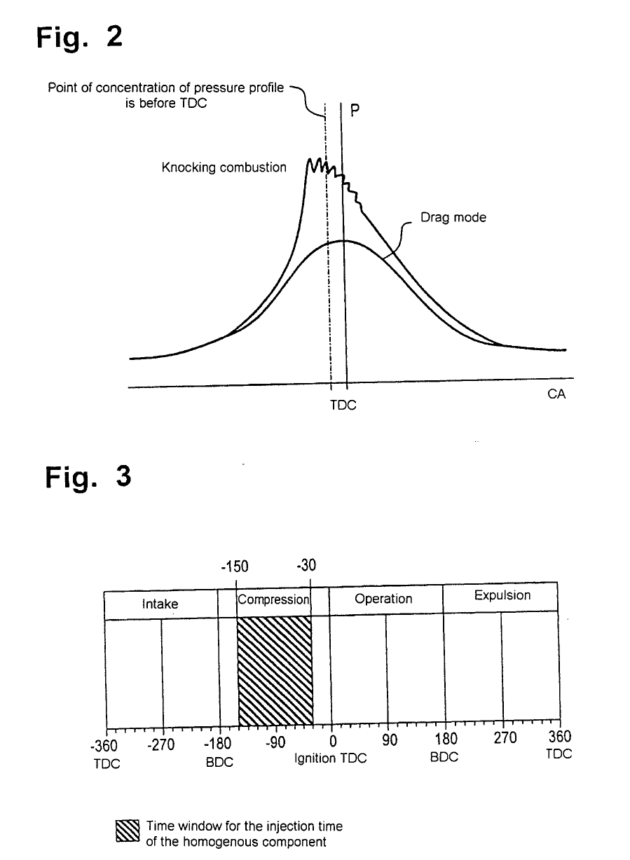

The internal combustion engine 1 operates according to the 4-stroke principle. A cylinder pressure profile of a homogenous combustion of the internal combustion engine 1 is illustrated with auto-ignition in FIG. 2, with the corresponding fuel injection times being represented according to FIG. 3. In a first intake cycle or intake stroke, the piston 5 moves in a downward direction from the top dead center 12 as far as a bottom dead center BDC. In this context, combustion air is fed to the combustion chamber 8 via an inlet duct (not illustrated). A certain quantity of exhaust gas from a previous working cycle is preferably added by an exhaust gas recirculation valve to the combustion air which is fed to the combustion chamber 8.

In a second compression stroke or compression cycle, the piston 5 moves in an upward direction from the bottom dead center BDC as far as an ignition top dead center TDC, fuel being injected just before TDC into the combustion chamber 8 which is filled with compressed air. In a subsequent expansion cycle, the piston 5 moves as a far as the bottom dead center BDC, with the exhaust gases from the combustion chamber 8 being expelled in a further expulsion cycle. The time of the injection of fuel can be between 150° CA and 30° CA of the TDC according to FIG. 3. The fuel ignites as a result of compression heat before TDC, with the combustion being concentrated significantly before TDC. The point where the combustion is concentrated is the piston position or the crank angle value at which 50% conversion of the mass of fuel involved in the combustion has taken place. According to FIG. 2, combustion occurs with a very large rise in pressure, leading to pressure oscillations and poor noise behavior. The unfavorable position of the combustion or the unfavorable point of concentration of the combustion makes the efficiency poor. If the time for homogenization is too short, high NOx emissions are also produced.

Different ignition takes place depending on the pre-injection quantity. If the pre-injection quantity is so low that the mixture becomes leaner, the ignition does not take place until the main injection quantity is injected, i.e. the main injection serves as an ignition jet. If the pre-injection quantity is large enough and the mixture does not become too lean, the pre-injection quantity is ignited. Given compression ratios between 12 and 21 and normal temperature peripheral conditions of the intake air temperature, component temperature, etc. the ignition takes place significantly before TDC, which results in a poor combustion concentration point of the pre-injection quantity. Furthermore the sudden combustion of the mixture gives rise to large increases in pressure and consequently to pressure oscillations. The ignition and the rise in pressure of the pre-injection component, of the main injection component and its maximum pressures and temperatures are influenced according to the invention by using a cooling liquid, for example water, and preferably in combination with exhaust gas recirculation.

According to the invention, two injection strategies are preferred. In the first variant, a cooling medium, preferably water or a second fuel with a high evaporation enthalpy can be introduced before the ignition of the homogenous mixture, resulting in a delay of the ignition time and a reduction in the rise in pressure. In the second variant, the cooling medium is introduced after the ignition of the homogenous mixture, which also reduces the rise in pressure.

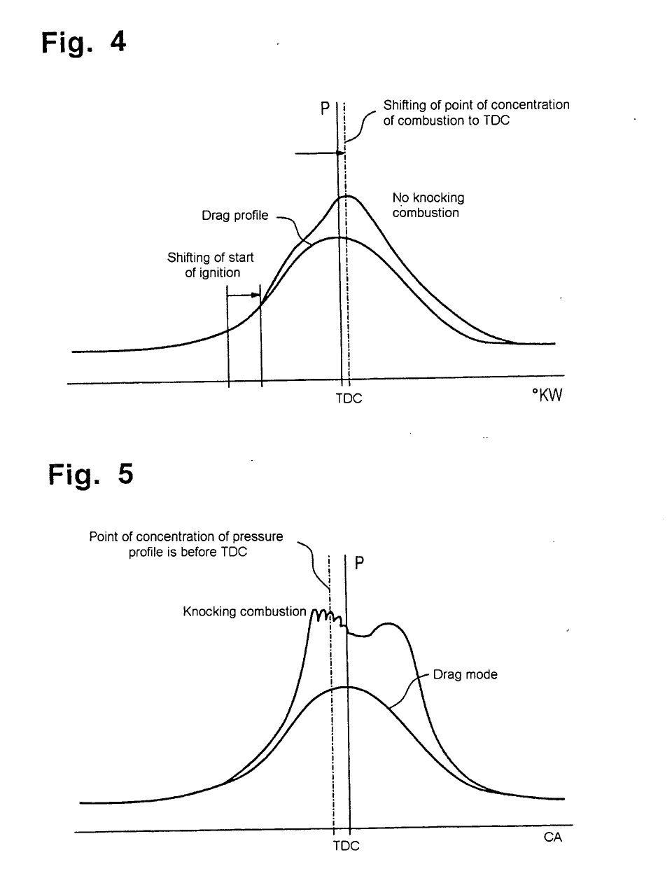

FIG. 4 shows a cylinder pressure profile for the combustion of a homogenous mixture in which the start of injection is shifted and the rise in pressure is reduced by cooling the fuel by injecting water in combination with exhaust gas recirculation so that the point of concentration of the combustion is shifted to TDC while avoiding knocking combustion. In this context, combustion control is carried out by means of exhaust gas recirculation and by utilizing cooling effects on the fuel.

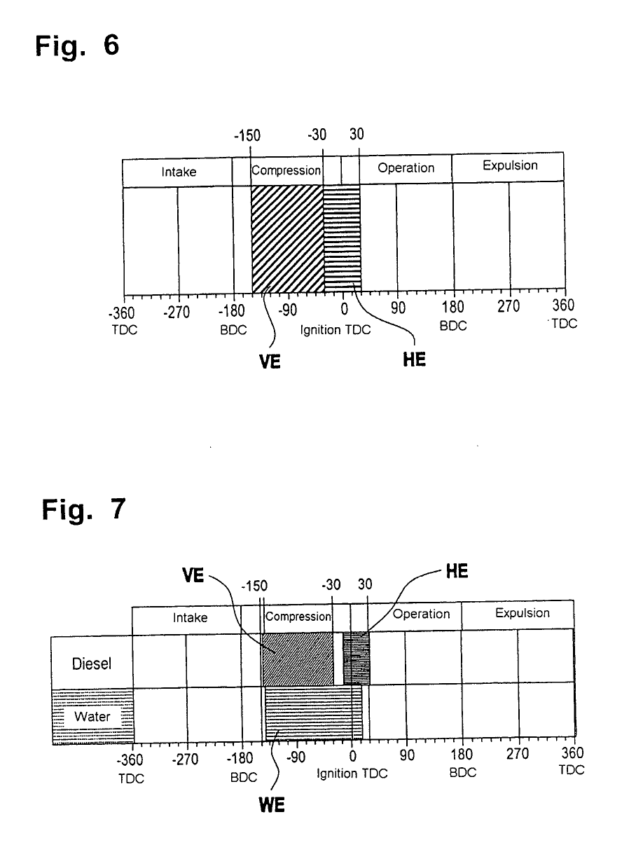

FIG. 6 illustrates an injection strategy of a combined combustion composed of a homogenous component and a heterogeneous component. In this context, a pre-injection VE is firstly performed in a region between 150° CA and 30° CA before TDC, with a main injection around the top dead center subsequently taking place preferably between 30° CA before TDC and 30° CA after TDC. FIG. 5 illustrates the pressure profile of such a combustion composed of a homogenous component and heterogeneous component.

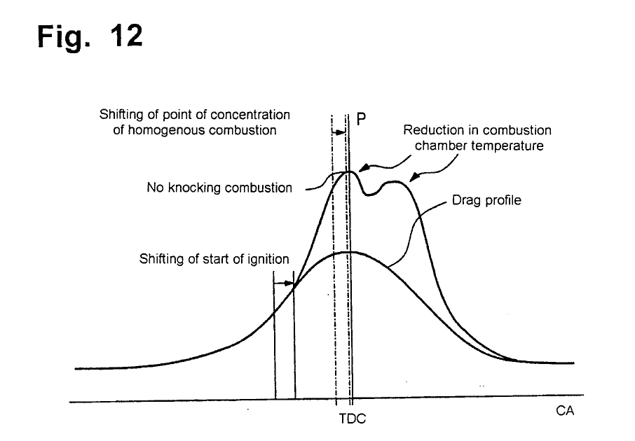

In order to optimize the combined homogenous/heterogeneous combustion according to the combustion illustrated in FIG. 5, water is injected so that a cylinder pressure profile according to FIG. 12 is obtained. The objective here is to shift the start of injection of the pre-injection quantity, to shift the point of concentration of the pre-injection combustion and to reduce the rise in pressure. Furthermore, the maximum combustion chamber temperature is reduced.

It is conceivable that, instead of water, a different liquid with a comparably high evaporation enthalpy is used. Alternatively, instead of the injection of water it is also possible to introduce a second fuel which also has a high evaporation enthalpy comparable to that of water.

FIG. 7 shows a first embodiment of such a fuel/water injection strategy for the internal combustion engine 1 for achieving a combustion chamber pressure profile according to FIG. 12. Here, in the compression stroke, first part of the fuel is injected into the combustion chamber 8 as a pre-injection, and this pre-injection can be performed in the intake stroke and/or compression stroke. The injection of water WE is started just before the start of the pre-injection VE with the latter being ended before the end of a main injection HE. The pre-injection which is performed brings about good distribution of the fuel in the combustion chamber so that a homogenous fuel/air mixture which is mixed with the injected water is formed. Using the injection of water delays the ignition of the pre-injected quantity of fuel and reduces the rise in pressure so that the center point of the combustion is displaced in the retarded direction. If the quantity of water were not used, the center point of the combustion according to FIG. 5 would be too early, which lowers the efficiency of the internal combustion engine 1. The large rise in pressure also leads to poor noise behavior without the addition of water and/or exhaust gas recirculation. The pre-injection VE of fuel preferably takes place between 150° CA and 30° CA before the TDC. A further quantity of fuel is then introduced into the combustion chamber 8 as a main injection HE in a region about the ignition top dead center TDC as a main injection HE. The main injection HE preferably takes place between 20° CA before the TDC and 30° CA after the TDC. The injection of water preferably takes place between 150° CA before the TDC and 20° CA after the TDC. Furthermore, after the main injection HE, a small quantity of fuel may be injected at a later time as a post-injection.

According to the first embodiment, the temperature level is lowered by the injection of the quantity of water and the evaporation of the pre-injected fuel is slowed down so that a later start of injection is achieved. The advantage of this injection strategy is that a combined homogenous/heterogeneous combustion with auto-ignition is ensured over the entire characteristic diagram. As a result, the components of the pre-injection and of the main injection can be varied as a function of load. Furthermore, the injection times of the homogenous component and the injection times of the heterogeneous component can be selected as a function of load and of rotational speed.

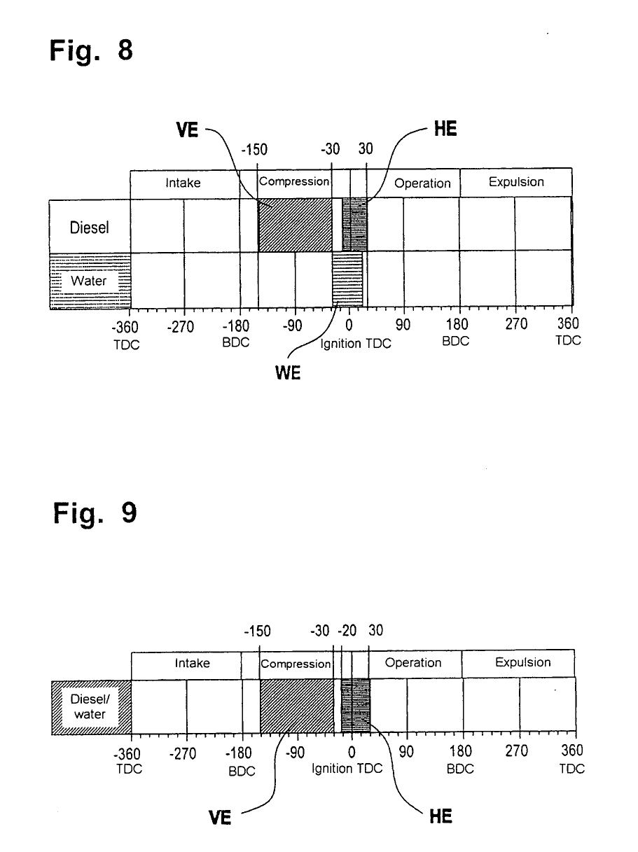

In a second embodiment of the fuel injection strategy according to FIG. 8, the injection of the quantity of water WE does not start until after the pre-injection VE has ended so that the quantity of water is not introduced until after the ignition of the homogenous mixture.

According to a third embodiment, the quantity of water WE is added to the fuel during the pre-injection VE and during the main injection HE within the injection device 13 in such a way that the water is injected into the combustion chamber 8 together with the fuel as a fuel/water emulsion in accordance with the injection strategy illustrated in FIG. 9. The objective of this injection strategy is that the aimed-at cooling effect is ensured so that the start of ignition is shifted and the rise in pressure is reduced during the pre-injection VE and the temperature level of the pre-injection and that of the main injection are lowered. In this context, the pre-injection VE of the fuel/water emulsion takes place between 150° CA and 30° CA before the TDC. The main injection HE of the fuel/water emulsion is performed between 20° CA before the TDC and 30° CA after the TDC.

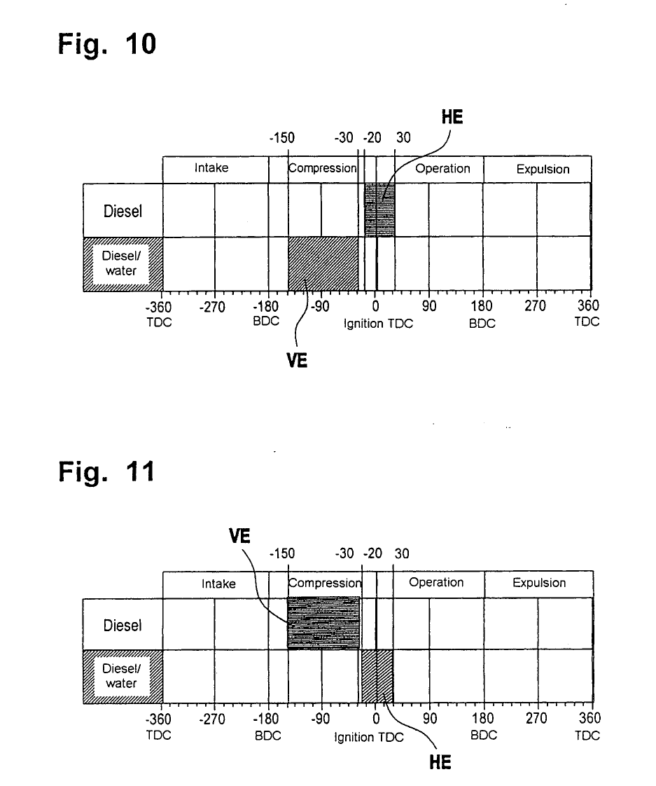

It is conceivable that according to a fourth embodiment the quantity of water WE is added only to the pre-injection VE within the injection device so that according to FIG. 10 a fuel/water emulsion or a fuel/water stratified arrangement is introduced into the combustion chamber in the form of a pre-injection. In this context, the pre-injection VE of the fuel/water emulsion or of a fuel/water stratified arrangement takes place between 150° CA and 30° CA before the TDC. The main injection HE of the fuel is performed between 20° CA before the TDC and 30° CA after the TDC.

Furthermore, it is conceivable that according to a fifth embodiment the quantity of water is added to the main injection HE within the injection device so that the fuel/water emulsion or water/fuel stratified arrangement according to FIG. 11 is introduced into the combustion chamber as a main injection HE. In this context, the pre-injection VE of the fuel takes place between 150° CA and 30° CA before the TDC. The main injection HE of the fuel/water emulsion or water/fuel stratified arrangement is performed between 20° CA before the TDC and 30° CA after the TDC.

According to the invention, a water/fuel stratified arrangement can be performed in all embodiments in such a way that the quantity of water is added to the fuel during the pre-injection and/or the main injection within the injection device in such a way that the water is introduced into the combustion chamber in the form of a fuel/water/fuel stratified arrangement or fuel/water stratified arrangement or water/fuel stratified arrangement.

According to a further embodiment, the pressure of the fuel introduced into the combustion chamber is changed during an injection process. In this context, it is possible, for example, for the injection pressure of the pre-injection VE to be at a lower level than the injection pressure of the main injection HE. As a result, wetting of the walls of the combustion chamber with fuel is avoided, in particular during the pre-injection. Furthermore, a higher fuel pressure preferably prevails during the main injection than during an optionally performed post-injection.

In order to achieve intensive homogenization of the pre-injected quantity of fuel, according to a further preferred embodiment, a fuel-jet cloud of fuel generated during an injection stroke is offset or laterally shifted during the pre-injection by means of a swirl movement performed in the combustion chamber so that during a subsequent injection stroke the newly injected fuel jets do not penetrate the cloud of fuel of the preceding injection stroke. This brings about optimum homogenization of the pre-injection quantity, which has a positive effect on the rise in pressure and thus improves the point of concentration of the combustion and the noise behavior. If a small pre-injection quantity is used, the ignition time of the pre-injection (ignition jet) can be influenced by the main injection by making the mixture leaner by means of the jet.

The invention is based on a method for operating an internal combustion engine with auto-ignition in which the fuel is injected directly into the combustion chamber as a pre-injection and a main injection and, if appropriate is injected as a post-injection by means of a fuel nozzle with a plurality of injection bores, with the pre-injection preferably taking place in a clocked fashion. In order to configure the combustion in an optimum way, a liquid which serves as a cooling medium, for example water, is introduced into the combustion chamber during the intake stroke and/or compression stroke so that a rise in pressure in the combustion chamber is reduced and, if appropriate, ignition of the pre-injection fuel amount is delayed. The liquid introduced into the combustion chamber cools the fuel, which delays the ignition of the pre-injection and reduces the rise in pressure so that an optimum center point of the combustion is achieved. Exhaust gas recirculation is preferably performed in order also to reduce even further the exhaust gas emissions which are formed, in particular the formation of NOx. If the quantity of fuel of the pre-injection is configured in such a way that the pre-injection quantity does not ignite owing to the pre-mixture being made leaner, the ignition time of the mixture and the rise in pressure are influenced by the injected liquid in the combustion chamber during the ignition by means of the main injection which is performed as an ignition jet.

What is claimed is:

1. A method for operating an internal combustion engine with auto-ignition including a cylinder having a combustion chamber and a fuel injection device for injecting fuel into the combustion chamber, said method comprising the steps of:
injecting fuel in different steps directly into the combustion chamber, such that a first part of the fuel is injected into the combustion chamber in a pre-injection step during one of an intake stroke and a compression stroke of the engine,
injecting additional fuel into the combustion chamber at a later time in the form of a main injection step or a post-injection step, introducing a liquid with a high evaporation enthalpy into the combustion chamber during one of the intake stroke, the compression stroke and the expansion stroke in order to cool the content of the combustion chamber thereby limiting a rise in pressure in the combustion chamber and delaying ignition of fuel injected respectively during the pre-injection and the main injection steps.

2. The method as claimed in claim 1, wherein the liquid is introduced into the combustion chamber during the pre-injection step.

3. The method as claimed in claim 1, wherein the liquid is introduced into the combustion chamber after the ending of the pre-injection of fuel.

4. The method as claimed in claim 1, wherein the introduction of liquid into the combustion chamber is ended before the end of the main fuel injection step.

5. The method as claimed in claim 1, wherein the liquid introduced into the combustion chamber is a quantity of water.

6. The method as claimed in claim 5, wherein the quantity of water is added to the fuel at least during one of the pre-injection and the main injection step in such a way that the water is introduced into the combustion chamber in the form of a fuel/water emulsion.

7. The method as claimed in claim 5, wherein the quantity of water is separately introduced into the combustion chamber by an additional injection device.

8. The method as claimed in claim 5, wherein the quantity of water is added to the fuel at least during one of the pre-injection and the main injection steps within the injection device in such a way that the water is introduced into the combustion chamber in one of a stratified fuel/water/fuel flow a stratified fuel/water flow and a stratified water/fuel flow.

9. The method as claimed in claim 1, wherein the pre-injection is performed in a compression stroke range of approximately 150° CA to 30° CA before the top dead center.

10. The method as claimed in claim 1, wherein the main fuel injection and, if appropriate, the post-injection are performed in series in a range of 20° CA before the top dead center to 40° CA after the top dead center.

11. The method as claimed in claim 1, wherein the pressure of the fuel introduced into the combustion chamber is changed during the fuel injection.

12. The method as claimed in claim 1, wherein the pre-injection is performed in a timed fashion, with a fuel-jet cloud generated during a fuel injection step being offset laterally during the pre-injection step by means of swirl movement of air entering the combustion chamber so that, during a subsequent injection step, newly formed fuel jets do not penetrate the cloud of fuel mixture formed by of the preceding fuel injection step.
